(19) United States
(12) Patent Application Publication
(10) Pub. No.: US 2026/0368850 A1
(43) Pub. Date: Nov. 19, 2026

(54) SELECTIVE HYBRID IMAGE UPSCALING BASED ON FRAME COMPLEXITY

(71) Applicant: QUALCOMM Incorporated, San Diego, CA (US)

(72) Inventors: Nan ZHANG, Beijing (CN); Jianying DUAN, Beijing (CN); Wenkai YAO, Beijing (CN)

(21) Appl. No.: 19/153,891

(22) PCT Filed: Apr. 4, 2023
(86) PCT No.: PCT/CN2023/086124

§ 371 Date: Aug. 5, 2025

(51) Int. Cl. G06T 3/4007; G06N 20/00; G06V 10/25; G06V 10/50

(52) U.S. Cl. CPC G06T 3/4007; G06N 20/00; G06V 10/25; G06V 10/50

(57) ABSTRACT

Certain aspects of the present disclosure provide techniques and apparatus for improved machine learning. A frame complexity of a frame output via a display of a user device is determined. In response to determining that the frame complexity of a first frame complexity satisfies one or more criteria, the frame is segmented into a plurality of regions. A first region, from the plurality of regions, is classified as a region of interest. In response to classifying the first region as the region of interest, a first upscaled region is generated, where generating the first upscaled region includes upscaling the first region using an upscaling machine learning model. At least a second upscaled region is generated, where generating the at least the second upscaled region includes upscaling at least a second region of the plurality of regions using interpolation. The first and second upscaled regions are output via the display of the user device.

### INTRODUCTION

Aspects of the present disclosure relate to machine learning.

An ever-increasing assortment of user devices are available to users to perform a wide variety of tasks and operations. In particular, mobile (e.g., battery powered) devices such as smartphones have become increasingly common. Although such mobile devices have seen significant advancements in computational capability, many devices are still inherently constrained by their limited physical size, as well as the desire to minimize power usage in order to maximize battery life. Such concerns and limitations can have notable impacts on the capabilities of the devices themselves.

For example, although machine learning models have been developed to perform various tasks (such as image upscaling) accurately and reliably, many machine learning approaches are computationally expensive and/or battery-intensive, substantially limiting their applicability for constrained devices such as mobile smartphones.

### BRIEF SUMMARY

Certain aspects of the present disclosure provide a processor-implemented method, comprising: determining a first frame complexity of a first frame output via a display of a user device; in response to determining that the first frame complexity satisfies one or more criteria, segmenting the first frame into a plurality of regions; classifying a first region, from the plurality of regions, as a region of interest; in response to classifying the first region as the region of interest, generating a first upscaled region, wherein generating the first upscaled region includes upscaling the first region using an upscaling machine learning model; generating at least a second upscaled region, wherein generating the at least the second upscaled region includes upscaling at least a second region of the plurality of regions using interpolation; and outputting the first and second upscaled regions via the display of the user device.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain aspects of the present disclosure and are therefore not to be considered limiting of the scope of this disclosure.

FIG. 1 depicts an example workflow for hybrid image upscaling based on frame complexity.

FIG. 2 is a flow diagram depicting an example method for hybrid image upscaling based on frame complexity.

FIG. 3 is a flow diagram depicting an example method for determining frame complexity to enable hybrid image upscaling.

FIG. 4 is a flow diagram depicting an example method for hybrid image upscaling based on region complexity.

FIG. 5 is a flow diagram depicting an example method for non-hybrid image upscaling based on frame complexity.

FIG. 6 is a flow diagram depicting an example method for hybrid image upscaling.

FIG. 7 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for more efficient implementation of machine learning and other computationally expensive operations.

In some aspects of the present disclosure, machine-learning-based image zooming (with upscaling) is used as an example operation that can be improved via selective or hybrid application of trained machine learning models. However, aspects of the present disclosure can be applied to a variety of use cases, and particularly to image processing operations.

As an example of limitations of at least some conventional systems, some conventional devices are substantially limited in their ability to provide runtime zoom, magnification, or enlargement of displayed items. Many applications that do support magnification do so only for limited content (e.g., only for the map portion of a navigation application), and do so by redrawing the specific content at a different scale, rather than actually upscaling the content to provide increased image resolution. At least some conventional systems simply cannot provide dynamic or readily available magnification of all content due at least in part to the added engineering efforts that such dynamic ability would entail. For example, applications are often designed to run on different devices with different display contexts (e.g., different resolutions, dots per inch (DPI), frames per second (FPS), and the like). Enabling conventional runtime zoom in such applications may substantially increase the user interface (UI) and content layout design and rendering engine efforts.

Additionally, visual quality and performance/power tradeoffs present further challenges. Some techniques such as bilinear or bicubic interpolation often fail to provide adequate results for some content, while other techniques such as machine-learning-based models are too battery-current-consuming and compute intensive to be conventionally used in many devices.

In some aspects of the present disclosure, techniques for selective hybrid image upscaling based on frame complexity are provided. In some aspects, to enable dynamic zoom or magnification on demand, machine learning models trained to upscale or increase the resolution of input images (referred to in some aspects as super resolution models) may be selectively used for some portions of displayed images or frames, while less computationally expensive techniques such as interpolation (e.g., bilinear interpolation) may be used for other portions of the displayed images or frames.

In this way, some aspects of the present disclosure can enable dynamic enlargement of displayed frames (e.g., frames output by a smartphone) with substantially reduced computational cost, as compared to conventional approaches. For example, machine-learning-based approaches are often too computationally expensive to be used to process the entire display/frame. Further, such models are often trained for complex imagery such as photographs, and provide suboptimal results for more simplistic content such as text. Moreover, simple interpolation is often insufficient for more complex regions such as photographs.

In some aspects, when a user initiates or requests a zoom or magnification of a displayed frame on a user device (e.g., by using a gesture such as double tapping the screen, pinching fingers on the screen, and the like), the upscaling system can perform regional histogram analysis to determine the complexity of each region of the displayed frame. For example, the system may determine whether the frame has high complexity in some regions (e.g., due to displayed photos) and low complexity in others (e.g., where text or UI elements are displayed). In some aspects, if such complexity is present in the frame, the upscaling system may segment the frame into regions (e.g., using edge detection or other techniques) and identify one or more regions of interest that can benefit from more complex upscaling (e.g., using machine learning models). The system can thereby selectively use the machine learning models only for these particular region(s), and may use other techniques such as interpolation upscaling for other regions.

In some aspects, by dynamically using a hybrid combination of upscaling techniques, device operability and efficiency can be substantially improved while minimizing computational expense and power usage.

### Example Workflow for Hybrid Image Upscaling Based on Frame Complexity

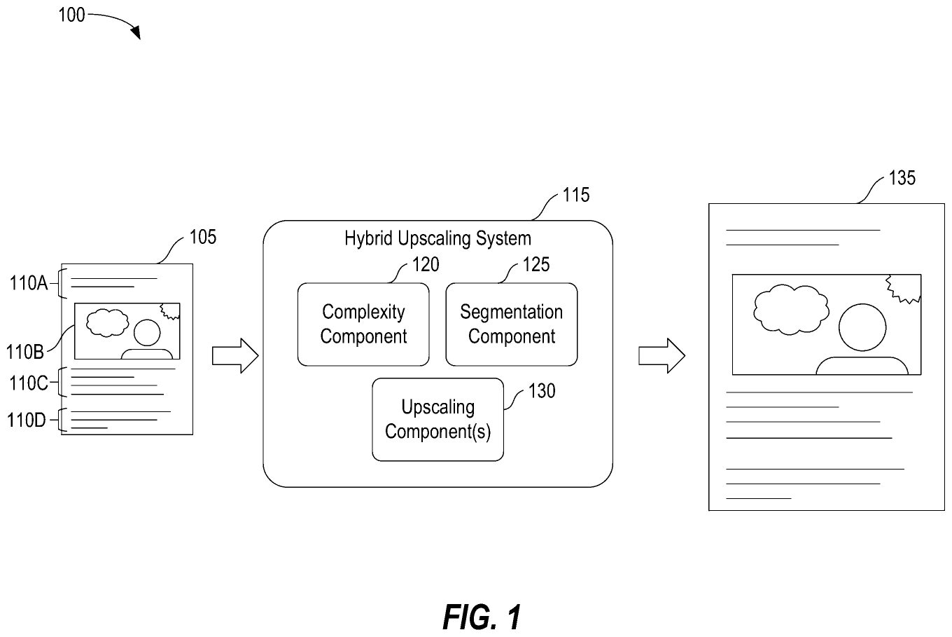

FIG. 1 depicts an example workflow 100 for hybrid image upscaling based on frame complexity.

In the illustrated example, a frame 105 is accessed by a hybrid upscaling system 115 to generate an upscaled frame 135. As used herein, a “frame” may generally refer to an image that can be output via a display or screen, such as on a smartphone or other user device. A frame may correspond to composite data, such as a combination of elements in different layers or regions. For example, a single frame may include UI elements (e.g., buttons and status bars), textual elements (e.g., written text in an article being displayed), imagery such as photographs and drawings, and the like. In some aspects, the frame 105 may correspond to the pixels displayed or output on a user device. For example, the user device may generate and output a sequence of frames (e.g., 60 frames per second) as video. In some aspects, the frame 105 may correspond to the entire display, including any status bars or other UI elements.

In the illustrated example, the frame 105 includes content 110A, 110B, 110C, and 110D (collectively, content 110). For example, the content 110A, 110C, and 110D may correspond to textual content (e.g., a status bar, an article title, article text, and the like), while content 110B corresponds to a photograph or other image, as shown. Generally, the complexity and arrangement of the content 110 may vary depending on the particular frame 105.

As used herein, “upscaling” generally refers to increasing the resolution of an image or frame 105 (e.g., by adding one or more pixels in one or more dimensions). For example, the upscaled frame 135 may depict a portion of the content of the original frame 105 at some higher resolution and zoomed in by some scaling factor (e.g., twice as large (2×)). Generally, the data in these additional pixels may be generated using a variety of techniques, including via machine learning (e.g., using a convolutional neural network (CNN) that has been trained to upscale images to process the pixels in the initial frame 105), via interpolation (e.g., using bilinear or bicubic interpolation from the existing pixels in the initial frame 105), and the like.

In the illustrated example, the hybrid upscaling system 115 includes a variety of components to generate the upscaled frame 135, including a complexity component 120, a segmentation component 125, and upscaling component(s) 130. Although depicted as discrete components for conceptual clarity, in some aspects, the operations of the depicted components (and others not depicted) may be combined or distributed across any number and variety of components. Additionally, although depicted as a discrete system for conceptual clarity, in some aspects, the operations of the hybrid upscaling system 115 may be performed by one or more systems or components, and may be implemented using hardware, software, or a combination of hardware and software. For example, in some aspects, the hybrid upscaling system 115 is implemented using one or more components of a user device, such as a smartphone.

In some aspects, the hybrid upscaling system 115 accesses the frames 105 as the frames are generated for display and/or as the frames are displayed. For example, each time the display is refreshed or a new frame 105 is output to the display, the frame 105 may also be provided to the hybrid upscaling system 115. In some aspects, rather than accessing all frames, the hybrid upscaling system 115 may selectively access frames 105 in response to one or more criteria or events, such as in response to detecting user input. For example, the hybrid upscaling system 115 may access the frame 105 in response to determining that (e.g., receiving an indication that) the user has requested or initiated a zoom, magnification, or enlargement operation of all or a portion of the frame 105. As used herein, accessing data (such as the frame 105) may generally include receiving, retrieving, requesting, extracting, obtaining, or otherwise gaining access to the data.

In the illustrated example, the complexity component 120 may be used to determine or evaluate the complexity of all or a portion of the frame 105. In some aspects, the complexity component 120 may perform or apply regional histogram analysis for a plurality of regions (also referred to as sections or tiles) in the frame 105. For example, the complexity component 120 may delineate the frame 105 into a set of tiles (e.g., using a grid) or other sections, and generate an image histogram for each such tile or other section. Generally, each image histogram may represent, for each section of the frame 105, the tonal distribution, intensity distribution, or other image complexity information of the section. For example, the histogram may indicate, for each respective value or alternative (e.g., each intensity value), the number of pixels in the section that have that respective value or alternative.

In some aspects, the complexity component 120 evaluates the complexity of each section in the frame 105 based on the shape and/or range of the corresponding histogram. For example, if the range of a histogram for a given section is small or below a threshold (e.g., with most values between 0 and 5, or between 245 and 255 for an 8-bit tonal value), the complexity component 120 may determine that the section is relatively non-complex. Conversely, if the range of the histogram for a given section is large or above a threshold (e.g., with values ranging from 0 to 240), the complexity component 120 may determine that the section is relatively complex. Similarly, in some aspects, the complexity component 120 may determine section complexity based on the presence and/or number of peaks in the histograms.

In some aspects, in addition to or instead of determining the complexity of each region, the complexity component 120 may determine the complexity of the entire frame (the “frame complexity”) based on comparing the histograms of each section. For example, in some aspects, if the range and/or shape of the histograms varies above a threshold (e.g., with some histograms having a small range and others having a large range) the complexity component 120 may determine that the frame 105 is complex. In some aspects, the complexity component 120 may determine that the frame 105 is complex if one or more sections are classified as non-complex based on their histograms, and one or more other sections are classified as complex based on their histograms.

In the depicted frame 105, for example, sections that include the content 110A, 110C, and 110D may be classified as non-complex, because their histograms likely have a small range and/or noticeable or well-defined sharp peaks (e.g., one peak for the background pixels and one for the text pixels). In contrast, sections that include the content 110B may be classified as complex, because the histogram shape is flatter and/or has a larger range.

In the illustrated workflow 100, if the complexity component 120 determines that the frame 105 does not satisfy one or more complexity criteria (e.g., because regional histogram analysis indicates that the sections are similarly complex to each other), the hybrid upscaling system 115 may use non-hybrid upscaling, as discussed in more detail below. That is, if the entire (or majority) of the frame 105 has similar complexity (e.g., all complex, such as when the entire frame 105 is a complex image, or all non-complex, such as when the entire frame 105 is text), the hybrid upscaling system 115 may use non-hybrid approaches to upscaling.

If the complexity component 120 determines that the complexity of the frame 105 meets the criteria (e.g., because one or more sections are complex while one or more other sections are not complex), the segmentation component 125 may be used to generate, identify, or otherwise determine segments (also referred to as regions) of the frame 105.

In some aspects, the particular techniques or operations used by the segmentation component 125 to segment the frame 105 into regions may vary depending on the particular implementation. For example, in some aspects, the segmentation component 125 may determine the regions based on defined layers or metadata associated with the frame 105 (e.g., with UI elements in one region, browser data in another, and the like). In some aspects, the segmentation component 125 may determine the regions using one or more edge detection techniques. In some aspects, the segmentation component 125 may determine the regions using one or more segmentation models that segment images into regions (e.g., trained CNNs or transformer-based models).

In the illustrated example, once the regions have been segmented or otherwise determined, the segmentation component 125 and/or the complexity component 120 may evaluate each region to identify or classify region(s) of interest (ROI(s)) in the frame 105. In some aspects, the ROI(s) may be identified based on information such as an indication of the position of each region in the frame 105, based on an indication of the position of user interaction with the frame 105 relative to the region, based on an indication of the complexity of the region, and the like.

For example, the position of a given region may be evaluated to determine the distance between the center or an edge of the region and the center of the frame 105, where smaller distances may be associated with an increased score or probability that the region is a ROI. As another example, the position of the user interaction may be evaluated to determine the distance between the interaction (e.g., the location where the user initiated or requested the enlargement or otherwise performed zoom input, such as where the user double tapped or pinched/spread his/her fingers on the frame 105) and the center or edges of the region, where smaller distances may be associated with an increased score or probability that the region is a ROI. As another example, the complexity of the region may be evaluated, such as using histogram analysis for the region, to determine whether the region is complex (e.g., whether the histogram has a small or large range, whether the histogram has one or more peaks, and the like), where increased complexity may be associated with an increased score or probability that the region is a ROI.

In the illustrated workflow 100, the upscaling component(s) 130 can then upscale each region (determined by the segmentation component 125) using one or more upscaling techniques or architectures, depending on the ROI classifications. In some aspects, the particular amount by which the regions are upscaled may vary depending on the particular implementation. For example, in some aspects, the upscaling component(s) 130 may upscale the regions based on a defined or fixed amount (e.g., an amount specified by the user or by a designer), such as by doubling the resolution. In some aspects, the upscaling component(s) 130 may upscale the regions based on the user input (e.g., based on the amount of zoom or magnification requested).

In some aspects, the upscaling component(s) 130 may use machine-learning-based upscaling for the one or more ROIs, and interpolation-based upscaling for the non-ROI regions. For example, in some aspects, the upscaling component(s) 130 may include an upscaling machine learning model (e.g., a CNN trained to perform upscaling, sometimes referred to as a “super resolution machine learning model”) that can be used for ROI(s), and other components that perform interpolation-based upscaling for other regions.

Although not depicted in the illustrated example, in some aspects, the hybrid upscaling system 115 may train and/or refine the upscaling machine learning model(s). That is, the hybrid upscaling system 115 may use training data (e.g., images at various resolutions) to train upscaling models (e.g., convolutional neural networks) to increase the resolution (and size in some cases) of input images. In some aspects, the hybrid upscaling system 115 may use pre-trained upscaling model(s).

In some aspects, the upscaled regions can then be collectively output or returned as the upscaled frame 135. In some aspects, the upscaled frame 135 is output on the display of the device. In some aspects, outputting the upscaled frame 135 includes allowing the user to zoom in and out on the upscaled frame 135 (e.g., using a finger separating or pinching gesture, respectively). That is, the upscaled frame 135 may be output at the size of the original frame 105 (e.g., to fill the screen), and the user may be allowed to zoom in and/or pan around the upscaled frame 135 as desired.

In this way, the hybrid upscaling system 115 can provide efficient image upscaling using a hybrid approach that selectively uses more computationally expensive approaches (e.g., convolution-based machine learning models) only for some regions of the frame 105 (e.g., for ROIs), and uses less computationally expensive approaches (e.g., interpolation-based upscaling) for other regions, such as regions that would not benefit from more complex approaches.

### Example Method for Hybrid Image Upscaling Based on Frame Complexity

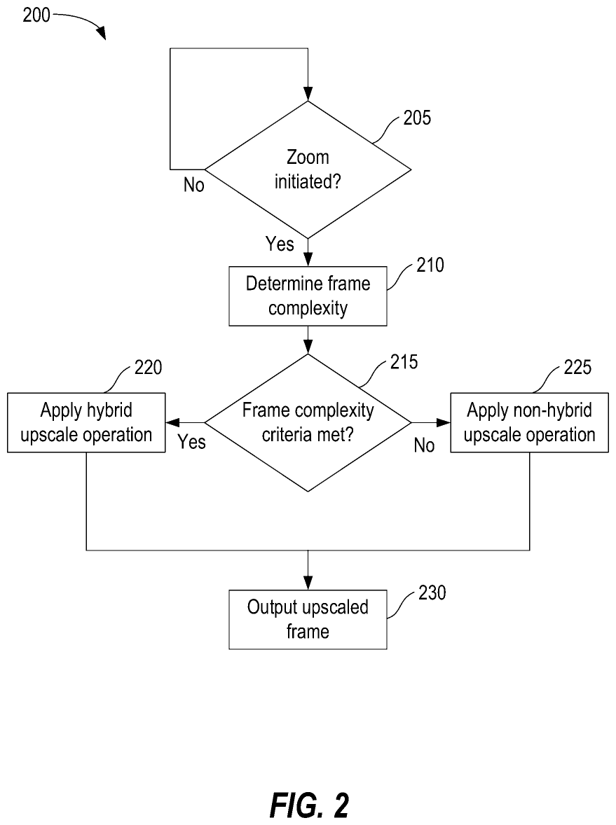

FIG. 2 is a flow diagram depicting an example method 200 for hybrid image upscaling based on frame complexity. In some aspects, the method 200 is performed by a hybrid upscaling system, such as the hybrid upscaling system 115 of FIG. 1.

At block 205, the hybrid upscaling system determines whether a zoom operation has been initiated. As discussed above, a “zoom” operation may alternatively be referred to as enlargement, magnification, and the like. In some aspects, the zoom operation may be initiated or requested according to a variety of criteria. For example, the hybrid upscaling system may determine whether a user has requested or initiated a zoom, such as by selecting or pressing a button or other UI element, by performing a gesture in air or on a touch screen of the device (e.g., pinching or spreading fingers, double tapping, and the like), or by some other input or user interaction.

If the hybrid upscaling system determines that the user has not initiated a zoom operation, then the method 200 iterates to block 205 to continue monitoring. In some aspects, the hybrid upscaling system may monitor for such zoom requests/initiations in the background, while the user device generates and outputs frames via the display. That is, the method 200 may iterate while other components of the user device continue to operate and/or output data.

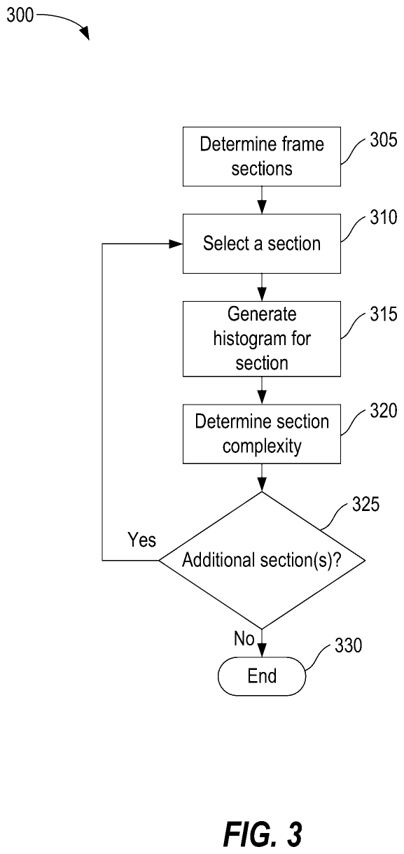

In the illustrated aspect, if the hybrid upscaling system determines that a zoom has been initiated, then the method continues to block 210. At block 210, the hybrid upscaling system determines the frame complexity of the frame that is currently being output (or the frame for which the user requested or initiated the zoom operation). Generally, the hybrid upscaling system may use a variety of techniques and operations to determine the frame complexity. For example, as discussed above, the hybrid upscaling system may use sectional histogram analysis on the frame. One example method for determining frame complexity is described in more detail below with reference to FIG. 3.

At block 215, the hybrid upscaling system determines whether one or more frame complexity criteria are satisfied. In some aspects, as discussed above, the frame complexity criteria relate to the relative or changing complexity across the frame. That is, if the frame is equally complex (either highly complex or highly non-complex) in each tile or section, then the hybrid upscaling system may determine that the criteria are not met. In some aspects, if one or more sections are determined to be complex while one or more other sections are determined to be non-complex, then the hybrid upscaling system may determine that the frame is complex and/or that the complexity criteria are satisfied. In some aspects, as discussed above, the hybrid upscaling system may determine whether the frame complexity criteria are met based on whether the shape and/or range of the sectional histograms differs above a threshold across the sections of the frame.

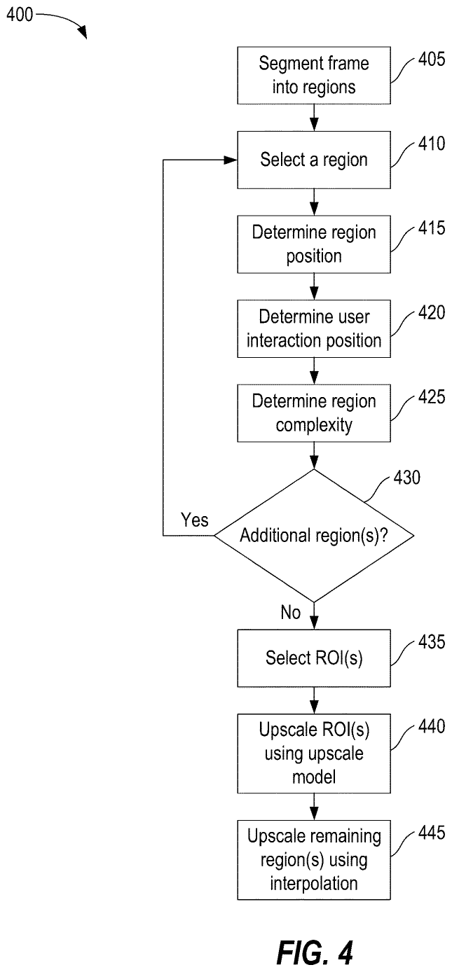

If, at block 215, the hybrid upscaling system determines that the frame complexity criteria are met, then the method 200 continues to block 220, where the hybrid upscaling system applies a hybrid upscaling operation. As discussed above, the hybrid upscale operation may generally include applying multiple different upscaling techniques or operations to different regions of the frame. For example, the hybrid upscaling system may apply an upscaling machine learning model to one or more regions (e.g., ROIs), and an interpolation upscaling to one or more other regions. One example method for performing hybrid upscaling is discussed in more detail below with reference to FIG. 4. The method 200 then continues to block 230.

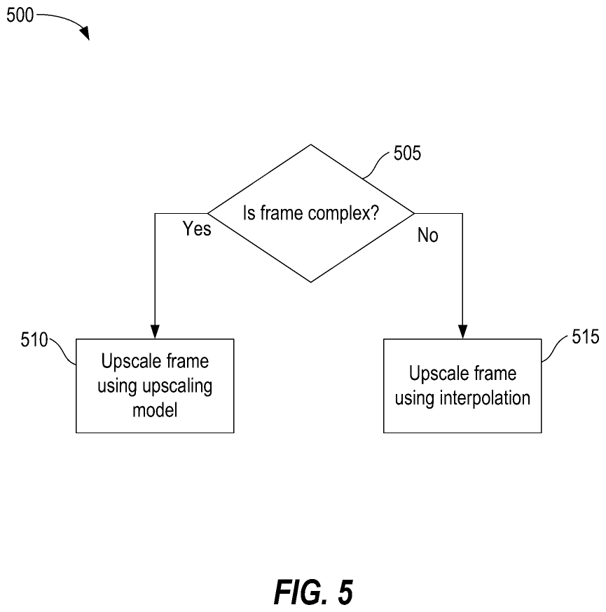

Returning to block 215, if the hybrid upscaling system determines that the frame complexity criteria are not met, then the method 200 continues to block 225, where the hybrid upscaling system applies a non-hybrid upscale operation (which may also be referred to as a “uniform upscale operation”). As discussed above, the non-hybrid upscale operation may generally include applying a single upscale technique or operation to the entire frame, rather than different techniques for each region. For example, the hybrid upscaling system may use an upscaling machine learning model if the entire frame is complex (e.g., the entire frame is a photograph or image), and use interpolation upscaling if the entire frame is non-complex (e.g., text). One example method for performing non-hybrid upscaling is discussed in more detail below with reference to FIG. 5. After the non-hybrid upscale operation is applied at block 225, the method 200 then continues to block 230.

At block 230, the hybrid upscaling system outputs the upscaled frame (generated using the hybrid upscaling at block 220 or the non-hybrid upscaling at block 225). As discussed above, outputting the upscaled frame may generally include outputting the upscaled frame via a display, such as the screen of a smartphone, allowing the user to view and/or interact with the frame at an increased resolution and/or size. In some aspects, the method 200 then begins anew or returns to block 205.

In this way, the hybrid upscaling system can provide efficient image or frame upscaling using a hybrid approach that selectively uses more computationally expensive approaches (e.g., convolution-based machine learning models) only for some regions of the frame and uses less computationally expensive approaches for other regions.

### Example Workflow for Determining Frame Complexity to Enable Hybrid Image Upscaling

FIG. 3 is a flow diagram depicting an example method 300 for determining frame complexity to enable hybrid image upscaling. In some aspects, the method 300 is performed by a hybrid upscaling system, such as the hybrid upscaling system 115 of FIG. 1. In some aspects, the method 300 corresponds to block 210 of FIG. 2.

At block 305, the hybrid upscaling system determines one or more frame sections (also referred to in some aspects as tiles) of the accessed or input frame. For example, in some aspects, the frame may be delineated or divided into a grid of tiles. Generally, the hybrid upscaling system may determine the frame sections using any suitable technique, and may or may not delineate the sections based on the contents of the frame itself. That is, the sections may be determined randomly or formulaically (e.g., using a fixed grid), without any consideration or evaluation of the actual contents of the frame itself.

At block 310, the hybrid upscaling system selects a section of the frame. Generally, the hybrid upscaling system may select the section using any suitable criteria, including randomly or pseudo-randomly, as each section may be evaluated during the method 300. Although the illustrated example depicts a sequential selection for conceptual clarity (e.g., where the hybrid upscaling system selects each section iteratively), in some aspects, the hybrid upscaling system may process some or all of the sections in parallel.

At block 315, the hybrid upscaling system generates a histogram for the selected section of the frame. As discussed above, the histogram may generally represent the intensity, color, and/or tonal distribution of pixels in the selected section.

At block 320, the hybrid upscaling system determines the section complexity of the selected section based on the histogram. For example, as discussed above, the hybrid upscaling system may determine the complexity based on the range and/or shape of the histogram (e.g., where larger ranges are indicative of increased complexity and/or where smaller peaks and/or more evenly distributed values in the histogram are indicative of increased complexity). In some aspects, the hybrid upscaling system may determine or generate a complexity score or measure for the section based on the histogram. In some aspects, in addition to or instead of generating a section-specific complexity, the hybrid upscaling system may generate histograms for each section and determine an overall frame complexity (e.g., by comparing the histograms), as discussed above.

At block 325, the hybrid upscaling system determines whether there is at least one additional section in the frame remaining for evaluation. If so, then the method 300 returns to block 310. If not, then the method 300 terminates to block 330.

In this way, the hybrid upscaling system can provide efficient image or frame upscaling using a hybrid approach that is selectively triggered based on regional complexity in the frame. This allows the hybrid upscaling system to use more computationally expensive approaches (e.g., convolution-based machine learning models) only for some regions of the frame and use less computationally expensive approaches for other regions.

### Example Method for Hybrid Image Upscaling Based on Region Complexity

FIG. 4 is a flow diagram depicting an example method 400 for hybrid image upscaling based on region complexity. In some aspects, the method 400 is performed by a hybrid upscaling system, such as the hybrid upscaling system 115 of FIG. 1. In some aspects, the method 400 corresponds to block 220 of FIG. 2.

At block 405, the hybrid upscaling system segments the frame into a set of one or more regions. As discussed above, the hybrid upscaling system may generally use a variety of techniques to segment the frame, including based on frame metadata, based on edge detection, based on machine-learning-based segmentation models, and the like. In some aspects, the segmentation may be performed based on the contents of the frame itself (as opposed to the sectional histogram analysis discussed above, which may be performed agnostically to the contents of the frame in some implementations).

At block 410, the hybrid upscaling system selects one of the segmented or otherwise determined regions. Generally, the hybrid upscaling system may select the region using any suitable criteria, including randomly or pseudo-randomly, as each region may be evaluated during the method 400. Although the illustrated example depicts a sequential selection for conceptual clarity (e.g., where the hybrid upscaling system selects each region iteratively), in some aspects, the hybrid upscaling system may process some or all of the regions in parallel.

At block 415, the hybrid upscaling system determines the positon of the selected region in the frame. For example, as discussed above, the hybrid upscaling system may determine the distance between the center of the region and the center of the frame, and/or between the center of the frame and the nearest side or edge of the region. As discussed above, in some aspects, the distance between the region and the frame center may be inversely correlated to a ROI score or measure for the region (e.g., to the probability that the region is classified as an ROI). That is, the smaller the distance (e.g., the closer the region is to the center), the more probable it is that the region will be classified as an ROI.

At block 420, the hybrid upscaling system determines the position of user interaction with the frame, relative to the selected region. For example, depending on the particular implementation, various interactions may be used to trigger or request the upscaling (and enlargement). In some aspects, the hybrid upscaling system may determine whether the request/interaction was performed within or near the region (e.g., whether the user double tapped or pulled apart fingers on the region displayed in the frame), or whether the user otherwise selected or indicated a point within the region (e.g., by selecting a zoom button, then selecting or pressing in the region). As discussed above, in some aspects, the distance between the region and the user interaction that initiated the zoom may be inversely correlated to the ROI score or measure.

At block 425, the hybrid upscaling system determines the complexity of the selected region. For example, as discussed above, the hybrid upscaling system may generate a histogram for the region, and evaluate the histogram to determine its range and/or shape. Based on the range/shape of the histogram, the hybrid upscaling system may determine a complexity of the region. In some aspects, the complexity of the region may be directly correlated to the ROI score or measure, such that more complex regions are more likely to be classified as ROIs.

At block 430, the hybrid upscaling system determines whether there is at least one additional identified region in the frame that has not yet been evaluated. If so, then the method 400 returns to block 410. If not, then the method 400 continues to block 435.

At block 435, the hybrid upscaling system selects, classifies, or otherwise determines zero or more ROI(s) in the frame. For example, as discussed above, the hybrid upscaling system may identify ROI(s) based on the region positions, user interaction position, and/or region complexities.

At block 440, the hybrid upscaling system can upscale any selected ROI(s) using an upscaling machine learning model, such as a CNN trained to increase resolution of input images. As discussed above, such models may generate high quality results, but often incur substantial cost of computational expense if applied over large areas or to cover a large number of pixels.

At block 445, the hybrid upscaling system can upscale any remaining (non-ROI) regions using interpolation. As discussed above, such interpolation may be inadequate for some content, but may be satisfactory for non-ROIs (e.g., for textual content).

In this way, the hybrid upscaling system can provide efficient image or frame upscaling using a hybrid approach that selectively uses more computationally expensive approaches (e.g., convolution-based machine learning models) only for some regions of the frame and uses less computationally expensive approaches for other regions.

### Example Method for Non-Hybrid Image Upscaling Based on Frame Complexity

FIG. 5 is a flow diagram depicting an example method 500 for non-hybrid image upscaling based on frame complexity. In some aspects, the method 500 is performed by a hybrid upscaling system, such as the hybrid upscaling system 115 of FIG. 1. In some aspects, the method 500 corresponds to block 225 of FIG. 2.

At block 505, the hybrid upscaling system determines whether the overall frame is complex. For example, in a similar manner to evaluating complexity of individual tiles, sections, or regions, the hybrid upscaling system may perform histogram analysis on the overall frame. In some aspects, in addition to or instead of generating a new histogram for the overall frame, the hybrid upscaling system may evaluate and/or aggregate previously generated histograms (e.g., the section histograms discussed above).

If the hybrid upscaling system determines that the frame is complex/that the frame complexity is above a threshold (e.g., because the histogram(s) have a wide range and/or because the histogram(s) have small peaks with great variability), then the method 500 continues to block 510. As discussed above, such complex frames or images may be well suited for machine-learning-based upscaling. At block 510, the hybrid upscaling system therefore upscales the entire frame by using an upscaling machine learning model (e.g., a convolutional neural network trained to increase image resolution), as discussed above.

Returning to block 505, if the hybrid upscaling system determines that the frame is not complex/that the frame complexity is below a threshold, (e.g., because the histogram(s) have a narrow range and/or because the histogram(s) have a small number of large peaks), then the method 500 continues to block 515. As discussed above, such non-complex frames may be well suited for computationally inexpensive interpolation upscaling techniques. At block 515, therefore, the hybrid upscaling system upscales the entire frame using one or more interpolation techniques, as discussed above.

In this way, the hybrid upscaling system can provide efficient image or frame upscaling using more computationally expensive approaches (e.g., convolution-based machine learning models) only for some frames, and using less computationally expensive approaches for other frames.

### Example Method for Hybrid Image Upscaling

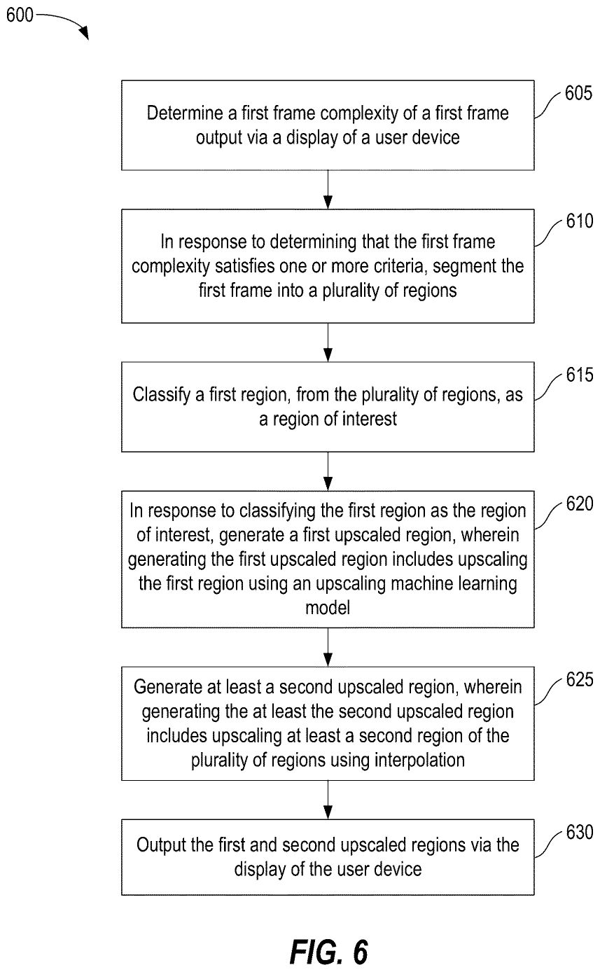

FIG. 6 is a flow diagram depicting an example method 600 for hybrid image upscaling. In some aspects, the method 600 is performed by a hybrid upscaling system, such as the hybrid upscaling system 115 of FIG. 1.

At block 605, a first frame complexity of a first frame output via a display of a user device is determined.

At block 610, in response to determining that the first frame complexity satisfies one or more criteria, the first frame is segmented into a plurality of regions.

At block 615, a first region, from the plurality of regions, is classified as a region of interest.

At block 620, in response to classifying the first region as the region of interest, a first upscaled region is generated. Generating the first upscaled region includes upscaling the first region using an upscaling machine learning model.

At block 625, at least a second upscaled region is generated. Generating the at least the second upscaled region includes upscaling at least a second region of the plurality of regions using interpolation.

At block 630, the first and second upscaled regions are output via the display of the user device.

In some aspects, determining the first frame complexity is performed in response to receiving an indication of a user request to enlarge at least a portion of the first frame.

In some aspects, determining the first frame complexity comprises performing histogram analysis for a plurality of sections of the first frame. In this case, determining that the first frame complexity satisfies the one or more criteria may include: determining that one or more of the plurality of sections are complex based on one or more complexity thresholds, and determining that one or more of the plurality of sections are not complex based on one or more complexity thresholds.

In some aspects, classifying the first region as the region of interest is performed based at least in part on at least one of (i) a position of the first region in the first frame, (ii) an indication of a position of a user interaction with the display while outputting the first frame, relative to the first region, or (iii) a complexity of the first region.

In some aspects, classifying the first region as the region of interest is performed based on a distance between the position of the first region and a center of the first frame.

In some aspects, the user interaction comprises a zoom input. In this case, classifying the first region as the region of interest may be performed based on determining that the zoom input is applied at the position of the first region.

In some aspects, classifying the first region as the region of interest is performed based on determining, using histogram analysis, that the first frame complexity of the first region satisfies one or more complexity criteria.

In some aspects, the method 600 further includes determining a second frame complexity of a second frame output via the display of the user device, and in response to determining that the second frame complexity does not satisfy the one or more criteria, refraining from segmenting the second frame into another plurality of regions.

In some aspects, the method 600 further includes, in response to determining that the second frame is complex, generating an upscaled frame. Generating the upscaled frame includes upscaling the second frame using the upscaling machine learning model.

In some aspects, the method 600 further includes, in response to determining that the second frame is not complex, generating an upscaled frame. Generating the upscaled frame includes upscaling the second frame using interpolation.

### Example Processing System Machine Learning

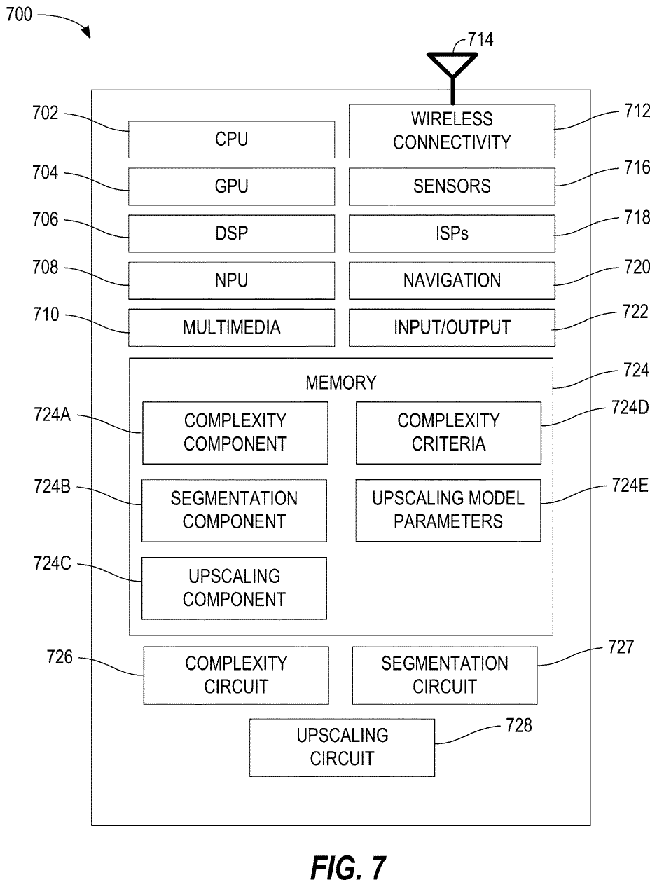

In some aspects, the workflows, techniques, and methods described with reference to FIGS. 1-6 may be implemented on one or more devices or systems. FIG. 7 depicts an example processing system 700 configured to perform various aspects of the present disclosure, including, for example, the techniques and methods described with respect to FIGS. 1-6. In some aspects, the processing system 700 may correspond to a hybrid upscaling system, such as the hybrid upscaling system 115 of FIG. 1. For example, the processing system 700 corresponds to a user device that includes or provides a hybrid upscaling system. Although depicted as a single system for conceptual clarity, in at least some aspects, as discussed above, the operations described below with respect to the processing system 700 may be distributed across any number of devices or systems.

Processing system 700 includes a central processing unit (CPU) 702, which in some examples may be a multi-core CPU. Instructions executed at the CPU 702 may be loaded, for example, from a program memory associated with the CPU 702 or may be loaded from a memory partition (e.g., a partition of memory 724).

Processing system 700 also includes additional processing components tailored to specific functions, such as a graphics processing unit (GPU) 704, a digital signal processor (DSP) 706, a neural processing unit (NPU) 708, a multimedia component 710 (e.g., a multimedia processing unit), and a wireless connectivity component 712.

An NPU, such as NPU 708, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as NPU 708, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, NPU 708 is a part of one or more of CPU 702, GPU 704, and/or DSP 706.

In some examples, wireless connectivity component 712 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity component 712 is further connected to one or more antennas 714.

Processing system 700 may also include one or more sensor processing units 716 associated with any manner of sensor, one or more image signal processors (ISPs) 718 associated with any manner of image sensor, and/or a navigation processor 720, which may include satellite-based positioning system components (e.g., GPS or GLONASS) as well as inertial positioning system components.

Processing system 700 may also include one or more input and/or output devices 722, such as screens, touch-sensitive surfaces (including touch-sensitive displays), physical buttons, speakers, microphones, and the like.

In some examples, one or more of the processors of processing system 700 may be based on an ARM or RISC-V instruction set.

Processing system 700 also includes memory 724, which is representative of one or more static and/or dynamic memories, such as a dynamic random access memory, a flash-based static memory, and the like. In this example, memory 724 includes computer-executable components, which may be executed by one or more of the aforementioned processors of processing system 700.

In particular, in this example, memory 724 includes a complexity component 724A, a segmentation component 724B, and an upscaling component 724C. The memory 724 also includes a set of complexity criteria 724D, and upscaling model parameters 724E. Though depicted as discrete components for conceptual clarity in FIG. 7, the illustrated components (and others not depicted) may be collectively or individually implemented in various aspects.

The complexity criteria 724D may generally correspond to thresholds or other criteria used to classify image sections, regions, or overall frames as complex or non-complex (e.g., based on histogram shapes and/or ranges), as discussed above. The upscaling model parameters 724E may generally correspond to the parameters of one or more models (e.g., e.g., weights and/or biases), such as upscaling machine learning models (e.g., convolutional neural networks trained to increase resolution of input images).

Processing system 700 further comprises complexity circuit 726, segmentation circuit 727, and upscaling circuit 728. The depicted circuits, and others not depicted, may be configured to perform various aspects of the techniques described herein.

For example, complexity component 724A and complexity circuit 726 (which may collectively correspond to the complexity component 120 of FIG. 1) may be used to determine the complexity of input frames and/or portions of frames (e.g., tiles, sections, or regions), as discussed above. Segmentation component 724B and segmentation circuit 727 (which may collectively correspond to the segmentation component 125 of FIG. 1) may be used to segment frames into regions based on the contents of each region, as discussed above. Upscaling component 724C and upscaling circuit 728 (which may collectively correspond to the upscaling component(s) 130 of FIG. 1) may be used to upscale frames and/or portions of frames using various techniques (such as machine-learning-based techniques, interpolation-based techniques, and the like), as discussed above.

Though depicted as separate components and circuits for clarity in FIG. 7, complexity circuit 726, segmentation circuit 727, and upscaling circuit 728 may collectively or individually be implemented in other processing devices of processing system 700, such as within CPU 702, GPU 704, DSP 706, NPU 708, and the like.

Generally, processing system 700 and/or components thereof may be configured to perform the methods described herein.

Notably, in other aspects, aspects of processing system 700 may be omitted, such as where processing system 700 is a server computer or the like. For example, multimedia component 710, wireless connectivity component 712, sensor processing units 716, ISPs 718, and/or navigation processor 720 may be omitted in other aspects. Further, aspects of processing system 700 maybe distributed between multiple devices.

### EXAMPLE CLAUSES

Implementation examples are described in the following numbered clauses:

Clause 1: A method, comprising: determining a first frame complexity of a first frame output via a display of a user device; in response to determining that the first frame complexity satisfies one or more criteria, segmenting the first frame into a plurality of regions; classifying a first region, from the plurality of regions, as a region of interest; in response to classifying the first region as the region of interest, generating a first upscaled region, wherein generating the first upscaled region includes upscaling the first region using an upscaling machine learning model; generating at least a second upscaled region, wherein generating the at least the second upscaled region includes upscaling at least a second region of the plurality of regions using interpolation; and outputting the first and second upscaled regions via the display of the user device.

Clause 2: A method according to Clause 1, wherein determining the first frame complexity is performed in response to receiving an indication of a user request to enlarge at least a portion of the first frame.

Clause 3: A method according to any of Clauses 1-2, wherein: determining the first frame complexity comprises performing histogram analysis for a plurality of sections of the first frame, and determining that the first frame complexity satisfies the one or more criteria comprises: determining that one or more of the plurality of sections are complex based on one or more complexity thresholds, and determining that one or more of the plurality of sections are not complex based on one or more complexity thresholds.

Clause 4: A method according to any of Clauses 1-3, wherein classifying the first region as the region of interest is performed based at least in part on at least one of (i) a position of the first region in the first frame, (ii) an indication of a position of a user interaction with the display while outputting the first frame, relative to the first region, or (iii) a complexity of the first region.

Clause 5: A method according to Clause 4, wherein classifying the first region as the region of interest is performed based on a distance between the position of the first region and a center of the first frame.

Clause 6: A method according to any of Clauses 4-5, wherein: the user interaction comprises a zoom input, and classifying the first region as the region of interest is performed based on determining that the zoom input is applied at the position of the first region.

Clause 7: A method according to any of Clauses 1-6, wherein classifying the first region as the region of interest is performed based on determining, using histogram analysis, that the first frame complexity of the first region satisfies one or more complexity criteria.

Clause 8: A method according to any of Clauses 1-7, further comprising: determining a second frame complexity of a second frame output via the display of the user device; and in response to determining that the second frame complexity does not satisfy the one or more criteria, refraining from segmenting the second frame into another plurality of regions.

Clause 9: A method according to Clause 8, further comprising, in response to determining that the second frame is complex, generating an upscaled frame, wherein generating the upscaled frame includes upscaling the second frame using the upscaling machine learning model.

Clause 10: A method according to Clause 8, further comprising, in response to determining that the second frame is not complex, generating an upscaled frame, wherein generating the upscaled frame includes upscaling the second frame using interpolation.

Clause 11: A processing system comprising: a memory comprising computer-executable instructions; and one or more processors configured to execute the computer-executable instructions and cause the processing system to perform a method in accordance with any of Clauses 1-10.

Clause 12: A processing system comprising means for performing a method in accordance with any of Clauses 1-10.

Clause 13: A non-transitory computer-readable medium comprising computer-executable instructions that, when executed by one or more processors of a processing system, cause the processing system to perform a method in accordance with any of Clauses 1-10.

Clause 14: A computer program product embodied on a computer-readable storage medium comprising code for performing a method in accordance with any of Clauses 1-10.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A processor-implemented method, comprising:
determining a first frame complexity of a first frame output via a display of a user device;
in response to determining that the first frame complexity satisfies one or more criteria, segmenting the first frame into a plurality of regions;
classifying a first region, from the plurality of regions, as a region of interest;
in response to classifying the first region as the region of interest, generating a first upscaled region, wherein generating the first upscaled region includes upscaling the first region using an upscaling machine learning model;
generating at least a second upscaled region, wherein generating the at least the second upscaled region includes upscaling at least a second region of the plurality of regions using interpolation; and
outputting the first and second upscaled regions via the display of the user device.

2. The processor-implemented method of claim 1, wherein determining the first frame complexity is performed in response to receiving an indication of a user request to enlarge at least a portion of the first frame.

3. The processor-implemented method of claim 1, wherein:
determining the first frame complexity comprises performing histogram analysis for a plurality of sections of the first frame, and
determining that the first frame complexity satisfies the one or more criteria comprises:
determining that one or more of the plurality of sections are complex based on one or more complexity thresholds, and
determining that one or more of the plurality of sections are not complex based on one or more complexity thresholds.

4. The processor-implemented method of claim 1, wherein classifying the first region as the region of interest is performed based at least in part on at least one of (i) a position of the first region in the first frame, (ii) an indication of a position of a user interaction with the display while outputting the first frame, relative to the first region, or (iii) a complexity of the first region.

5. The processor-implemented method of claim 4, wherein classifying the first region as the region of interest is performed based on a distance between the position of the first region and a center of the first frame.

6. The processor-implemented method of claim 4, wherein:
the user interaction comprises a zoom input, and
classifying the first region as the region of interest is performed based on determining that the zoom input is applied at the position of the first region.

7. The processor-implemented method of claim 4, wherein classifying the first region as the region of interest is performed based on determining, using histogram analysis, that the first frame complexity of the first region satisfies one or more complexity criteria.

8. The processor-implemented method of claim 1, further comprising:
determining a second frame complexity of a second frame output via the display of the user device; and
in response to determining that the second frame complexity does not satisfy the one or more criteria, refraining from segmenting the second frame into another plurality of regions.

9. The processor-implemented method of claim 8, further comprising, in response to determining that the second frame is complex, generating an upscaled frame, wherein generating the upscaled frame includes upscaling the second frame using the upscaling machine learning model.

10. The processor-implemented method of claim 8, further comprising, in response to determining that the second frame is not complex, generating an upscaled frame, wherein generating the upscaled frame includes upscaling the second frame using interpolation.

11. A processing system, comprising:
a memory comprising computer-executable instructions; and
one or more processors configured to execute the computer-executable instructions and cause the processing system to perform an operation comprising:
determining a first frame complexity of a first frame output via a display of a user device;
in response to determining that the first frame complexity satisfies one or more criteria, segmenting the first frame into a plurality of regions;
classifying a first region, from the plurality of regions, as a region of interest;
in response to classifying the first region as the region of interest, generating a first upscaled region, wherein generating the first upscaled region includes upscaling the first region using an upscaling machine learning model;
generating at least a second upscaled region, wherein generating the at least the second upscaled region includes upscaling at least a second region of the plurality of regions using interpolation; and
outputting the first and second upscaled regions via the display of the user device.

12. The processing system of claim 11, wherein determining the first frame complexity is performed in response to receiving an indication of a user request to enlarge at least a portion of the first frame.

13. The processing system of claim 11, wherein:
determining the first frame complexity comprises performing histogram analysis for a plurality of sections of the first frame, and
determining that the first frame complexity satisfies the one or more criteria comprises:
determining that one or more of the plurality of sections are complex based on one or more complexity thresholds, and
determining that one or more of the plurality of sections are not complex based on one or more complexity thresholds.

14. The processing system of claim 11, wherein classifying the first region as the region of interest is performed based at least in part on at least one of (i) a position of the first region in the first frame, (ii) an indication of a position of a user interaction with the display while outputting the first frame, relative to the first region, or (iii) a complexity of the first region.

15. The processing system of claim 14, wherein classifying the first region as the region of interest is performed based on a distance between the position of the first region and a center of the first frame.

16. The processing system of claim 14, wherein:
the user interaction comprises a zoom input, and
classifying the first region as the region of interest is performed based on determining that the zoom input is applied at the position of the first region.

17. The processing system of claim 14, wherein classifying the first region as the region of interest is performed based on determining, using histogram analysis, that the first frame complexity of the first region satisfies one or more complexity criteria.

18. The processing system of claim 11, the operation further comprising:
determining a second frame complexity of a second frame output via the display of the user device; and
in response to determining that the second frame complexity does not satisfy the one or more criteria, refraining from segmenting the second frame into another plurality of regions.

19. The processing system of claim 18, the operation further comprising, in response to determining that the second frame is complex, generating an upscaled frame, wherein generating the upscaled frame includes upscaling the second frame using the upscaling machine learning model.

20. The processing system of claim 18, the operation further comprising, in response to determining that the second frame is not complex, generating an upscaled frame, wherein generating the upscaled frame includes upscaling the second frame using interpolation.

21-30. (canceled)
